(19) United States
(12) Patent Application Publication
(10) Pub. No.: US 2009/0197120 A1
(43) Pub. Date: Aug. 6, 2009

(54) MAGNETIC RECORDING MEDIUM AND MAGNETIC RECORDING APPARATUS

(75) Inventors: Jun Taguchi, Kawasaki (JP); Yuta Toyoda, Kawasaki (JP); Takuya Uzumaki, Kawasaki (JP); Tsutomu Tanaka, Kawasaki (JP); Toshio Sugimoto, Kawasaki (JP); Nobuhide Aoyama, Kawasaki-shi (JP); Ryosaku Inamura, Kawasaki (JP); Ryo Kurita, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/240,419

(22) Filed: Sep. 29, 2008

(30) Foreign Application Priority Data
Feb. 1, 2008 (JP) 2008-023194

(51) Int. Cl. G11B 5/66

(52) U.S. Cl. 428/800

(57) ABSTRACT

A magnetic recording medium for vertical magnetic recording includes a substrate, and a layer laminated on the substrate, including a first magnetic recording layer made of a granular material, an exchange-coupling-strength control layer, a second magnetic recording layer made of a granular material, and a third magnetic recording layer made of a non-granular material.

### BACKGROUND OF THE INVENTION

1. Field of the Invention

The present invention relates to a magnetic recording medium for vertical magnetic recording and a magnetic recording apparatus having the magnetic recording medium and, in particular, to a magnetic recording medium and magnetic recording apparatus with a high reversed-magnetic-field reduction effect and an excellent recording and replay resolution.

2. Description of the Related Art

Vertical magnetic recording media can record information in higher density compared with conventional in-plane magnetic recording media. To further increase recording density of such a vertical magnetic recording medium, the reversal of recording magnetic field of the medium has to be reduced. As one way for solving this problem, the Exchange Coupled Composite medium (ECC medium) technology has been studied (for example, refer to Japanese Patent Application Laid-open No. 2006-209943).

The ECC medium technology is a technology of reducing a reversed recording magnetic field of a medium by dividing a high Hk (anisotropic magnetic field) magnetic recording layer and a low Hk magnetic recording layer with an exchange-coupling-strength control layer made of non-magnetic metal to control the coupling strength between the magnetic recording layers.

In a conventional vertical recording medium, as depicted in an example of FIG. 6, a technology is used such that a magnetic recording layer is made as two layers, with a first magnetic recording layer (lower recording layer) 30d being made of a granular material of a CoCrPt alloy or the like with a relatively large Hk and an oxide, thereby increasing the recording and replay resolution. On the other hand, for a second magnetic recording layer (upper recording layer) 30e, a non-granular material with a relatively small Hk, such as a CoCrPt alloy is adopted in view of keeping smoothness of the medium surface and write capability.

Thus, to apply the ECC technology to the conventional vertical recording media, as depicted in an example of FIG. 7, inserting an exchange-coupling-strength control layer 40g between the high-Hk lower recording layer 30d and the low-Hk upper recording layer 30e is an easy solution.

However, when the exchange-coupling-strength control layer 40g is inserted between the lower recording layer 30d and the upper recording layer 30e in the conventional vertical recording medium, a problem arises such that a reversed-magnetic-field reduction effect cannot be sufficiently achieved. Moreover, when the exchange-coupling-strength control layer 40g is inserted, the recording and replay resolution is disadvantageously degraded.

### SUMMARY

It is an object of the present invention to at least partially solve the problems in the conventional technology.

A magnetic recording medium according to one aspect of the present invention is a magnetic recording medium for vertical magnetic recording, and includes a substrate, and a layer laminated on the substrate, including a first magnetic recording layer made of a granular material, an exchange-coupling-strength control layer, a second magnetic recording layer made of a granular material, and a third magnetic recording layer made of a non-granular material.

A magnetic recording apparatus according to another aspect of the present invention includes a magnetic recording medium for vertical magnetic recording, and the magnetic recording medium includes a substrate, and a layer laminated on the substrate, including a first magnetic recording layer made of a granular material, an exchange-coupling-strength control layer, a second magnetic recording layer made of a granular material, and a third magnetic recording layer made of a non-granular material.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a cross-section view of a magnetic recording apparatus according to an embodiment of the present invention;

FIG. 2 is a drawing of one configuration of a magnetic recording medium according to the embodiment;

FIG. 3 is a drawing of another configuration of the magnetic recording medium according to the embodiment;

FIG. 4 is a graph representing a reversed-magnetic-field reduction effect for a media relative to thickness of an exchange-coupling-strength control layer;

FIG. 5 is a graph of S/N characteristics;

FIG. 6 is a drawing of one example of a configuration of a conventional vertical recording medium; and

FIG. 7 is a drawing of one example of an conventionally-designed ECC medium.

### DETAILED DESCRIPTION OF THE PREFERRED EMBODIMENTS

With reference to the attached drawings, exemplarily embodiments of a magnetic recording medium and a magnetic recording apparatus according to the present invention are explained in detail below.

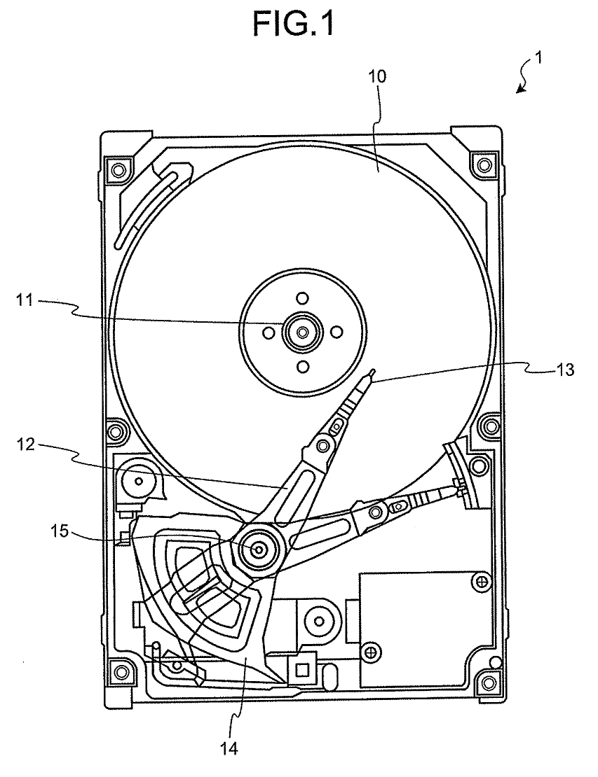

First, a magnetic recording apparatus 1 including a magnetic recording medium 10 according to a present embodiment is explained. FIG. 1 is a cross-section view of the magnetic recording apparatus 1. In FIG. 1, the magnetic recording medium 10 is a vertical magnetic recording medium that stores various types of information with high density, and is driven for rotation by a spindle motor 11.

Reading and writing of the magnetic recording medium 10 is performed by a head 13 provided at one end of an arm 12, which is a head supporting mechanism. The head 13 performs reading and writing by staying in a state of floating slightly above the surface of the magnetic recording medium 10 with a lift caused by the rotation of the magnetic recording medium 10. Further, with the driving of a voice coil motor 14, which is a head driving mechanism provided at another end of the arm 12, the arm 12 is rotated along an arc centering on a shaft 15, thereby causing the head 13 to make a seek move in a track crossing direction of the magnetic recording medium 10, thereby changing the track to be read or written.

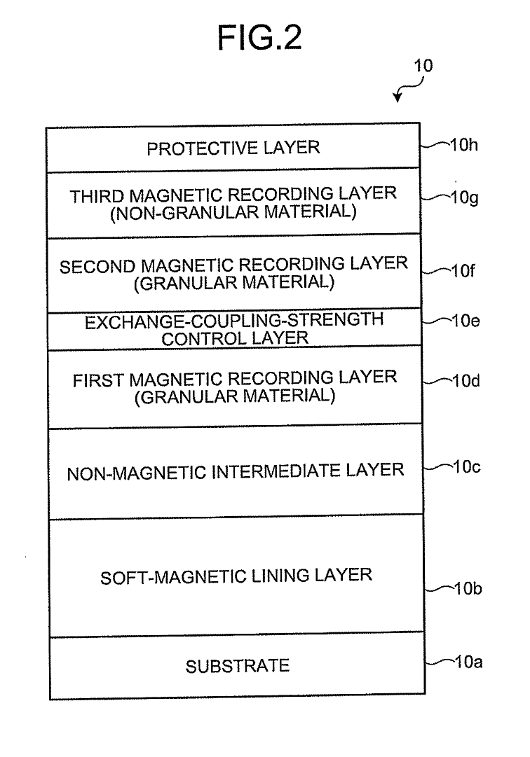

Next, the configuration of the magnetic recording medium 10 according to the present embodiment is explained. FIG. 2 is a drawing of the configuration of the magnetic recording medium 10 according to the present embodiment. As depicted in the drawing, the magnetic recording medium 10 is configured by laminating, on a substrate 10a, a soft-magnetic lining layer 10b, a non-magnetic intermediate layer 10c, a first magnetic recording layer 10d, an exchange-coupling-strength control layer 10e, a second magnetic recording layer 10f, a third magnetic recording layer 10g, and a protective layer 10h.

Here, for the first magnetic recording layer 10d and the second magnetic recording layer 10f, a granular material made of a CoCrPt alloy or the like and an oxide are adopted. For the third magnetic recording layer 10g, an alloy material containing CoCrPt or the like is adopted. That is, an exchange-coupling-strength control layer is inserted between a lower recording layer and an upper recording layer of a conventional vertical recording medium, and further the upper recording layer is configured with two layers, one with a granular material and another with a non-granular material.

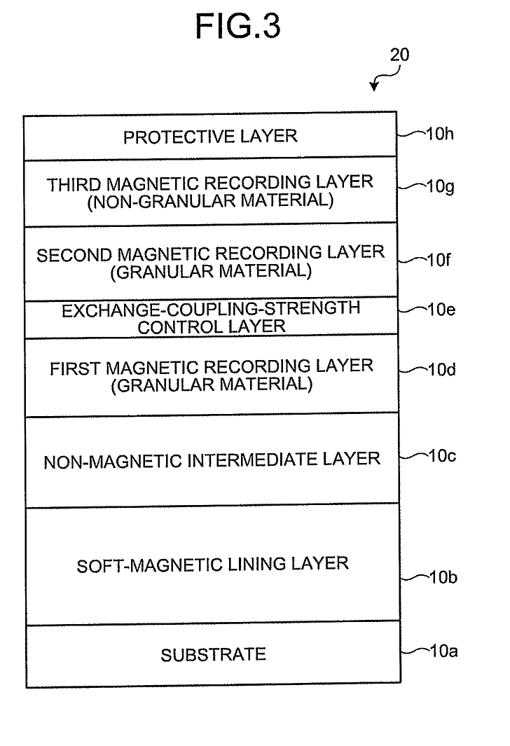

Note that, though the magnitude relation in Hk among the first magnetic recording layer 10d, the second magnetic recording layer 10f, and the third magnetic recording layer 10g is preferably: Hk of the first magnetic recording layer 10d>Hk of the second magnetic recording layer 10f, the third magnetic recording layer 10g. The order of Hk magnitude between the first magnetic recording layer 10d and the second magnetic recording layer 10f may be reversed, as a magnetic recording medium 20 depicted in FIG. 3.

With the configuration of the magnetic recording medium as depicted in FIG. 2 or 3, the reversed-magnetic-field reduction effect can be increased. Further, by arranging the second magnetic recording layer 10f made of a granular material above the exchange-coupling-strength control layer 10e, the magnetic coupling strength in an in-plane direction of the third magnetic recording layer 10g made of a non-granular material arranged above the second magnetic recording layer can be suppressed. As a result, an improvement in recording and replay resolution of the medium can be achieved.

Next, effects of the magnetic recording media 10 and 20 according to the present embodiments are explained in comparison with the conventional magnetic recording medium. Here, a specific medium configuration of each magnetic recording medium for use in comparison is as follows.

In a specific medium configuration of the magnetic recording medium 10 depicted in FIG. 2, a glass substrate is used for the substrate 10a, an amorphous FeCo alloy with high magnetic permeability is used for the soft-magnetic lining layer 10b. For the non-magnetic intermediate layer 10c, to achieve a function of promoting a perpendicular-to-surface orientation of an axis of easy magnetization, Ru is used, which is excellent in lattice matching with a magnetic recording layer.

Further, for the first magnetic recording layer 10d, a granular material with SiO₂ being added to a CoCrPt alloy is used, where the Pt composition amount is 20 atom percent [at.%] to achieve high Hk. For the exchange-coupling-strength control layer 10e, Ru is used, which is a non-magnetic material excellent in lattice matching with a magnetic recording layer.

Furthermore, for the second magnetic recording layer 10f, a granular material with SiO₂ being added to a CoCrPt alloy is used, where the Pt composition amount is 15 atom percent to achieve lower Hk than that of the first magnetic recording layer 10d. For the third magnetic recording layer 10g, CoCrPtB is used, which is obtained by adding B to a CoCrPt alloy. By adding B, effects of promoting finer grains and segregation of Cr can be expected. With the Pt composition amount of the third magnetic recording layer 10g being 15 atom percent, Hk is lower than that of the first magnetic recording layer 10d.

In a specific medium configuration of the magnetic recording medium 20 depicted in FIG. 3, materials similar to those of the magnetic recording medium 10 are used for the respective layers, except that the Pt composition of the first magnetic recording layer 10d being 15 atom percent and the Pt composition of the second magnetic recording layer 10f being 20 atom percent so that Hk of the second magnetic recording layer 10f is higher than Hk of the first magnetic recording layer 10d.

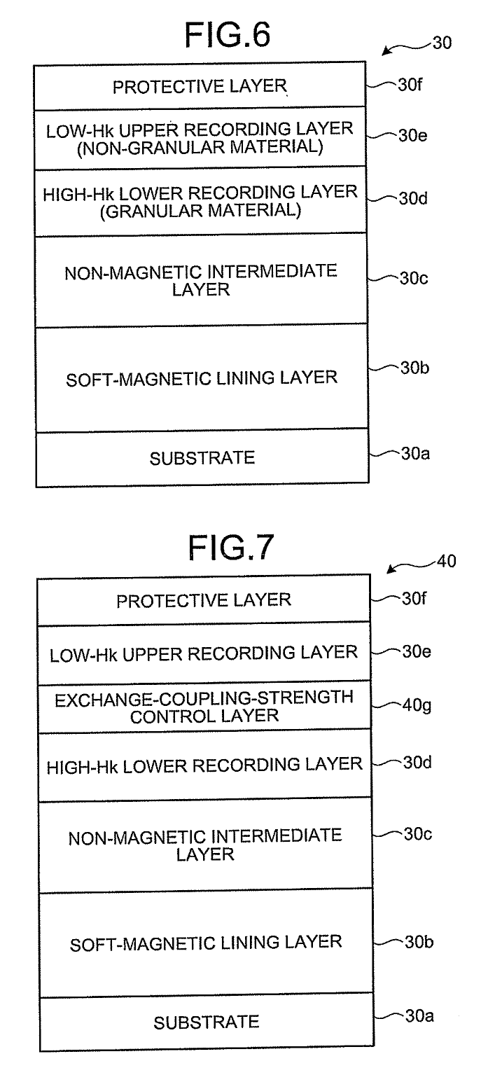

In a specific medium configuration of a magnetic recording medium 30 depicted in FIG. 6, as with the magnetic recording media 10 and 20, a glass substrate is used for a substrate 30a, a FeCo alloy is used for a soft-magnetic lining layer 30b, and Ru is used for a non-magnetic intermediate layer 30c. For the first magnetic recording layer 30d, a granular material obtained by adding SiO₂ to a CoCrPt alloy is used so as to have a Pt composition amount of 20 atom percent for high Hk. Further, for the second magnetic recording layer 30e, CoCrPtB with a Pt composition amount of 15 atom percent is used.

In a specific medium configuration of a magnetic recording medium 40 depicted in FIG. 7, as with the magnetic recording medium 10, Ru is used for the exchange-coupling-strength control layer 40g. For the other layers, materials similar to those of the magnetic recording medium 30 are used.

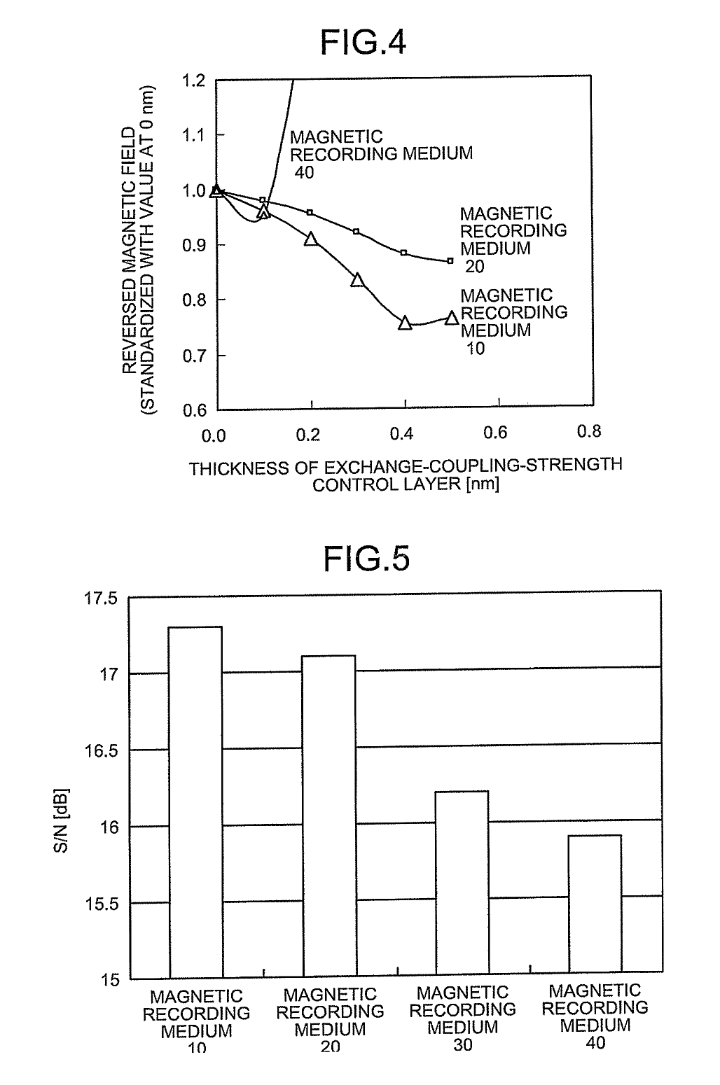

FIG. 4 is a graph representing an effect of reducing reversal of a magnetic field in the media relative to the thickness of the exchange-coupling-strength control layer. As depicted in FIG. 4, by adjusting the thickness of the exchange-coupling-strength control layer to an appropriate layer thickness, a reduction of the reversed magnetic field can be observed. In the magnetic recording medium 20, compared with the magnetic recording medium 40, which is a conventionally-designed ECC medium, the effect of reversed magnetic field reduction is increased. In the magnetic recording medium 10, the effect of reversed magnetic field reduction is further increased than that of the magnetic recording medium 20.

FIG. 5 is a graph of S/N characteristics. As depicted in FIG. 5, the magnetic recording medium 10 has the best S/N characteristic of all, and the magnetic recording medium 20 comes second best in S/N characteristic. This means that the magnetic recording-media 10 and 20 have recording and replay resolutions higher than that of the conventional magnetic recording medium 30. On the other hand, the magnetic recording medium 40, which is a conventionally-designed ECC medium, has its S/N characteristic degraded more than that of the magnetic recording medium 30, indicating that the recording and replay resolution is degraded.

Note that the configurations of the magnetic recording media 10 and 20 according to the present embodiments can be variously modified without deviating from the gist of the present invention. For example, layers other than the first magnetic recording layer 10d, the exchange-coupling-strength control layer 10e, the second magnetic recording layer 10f, and the third magnetic recording layer 10g do not have to be exactly the same as depicted in FIGS. 2 and 3. Furthermore, the components and compositions of the respective layers do not have to be exactly the same as explained in the above embodiments.

According to the magnetic recording medium and the magnetic recording apparatus according to the present invention, a magnetic recording medium and a magnetic recording apparatus with a high reversed-magnetic-field reduction effect and an excellent recording and replay resolution can be obtained, whereby the recording density of the magnetic recording medium and the magnetic recording apparatus can be improved.

According to the embodiments, it has been confirmed by experiment that a reversed-magnetic-field reduction effect can be increased when the recording layer above the exchange-coupling-strength control layer is formed of two layers, that is, the second magnetic recording layer and the third magnetic recording layer, with the second magnetic recording layer being made of a relatively high-Hk granular material and the third magnetic recording layer being made of a relatively low-Hk non-granular material.

Further, by arranging the second magnetic recording layer made of the granular material above the exchange-coupling-strength control layer, a magnetic coupling strength in an in-plane direction of the third magnetic recording layer made of the non-granular material arranged above the second magnetic recording layer can be suppressed, whereby a recording and replay resolution of the medium can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A magnetic recording medium for vertical magnetic recording, comprising:
a substrate; and
a layer laminated on the substrate, including
a first magnetic recording layer made of a granular material,
an exchange-coupling-strength control layer,
a second magnetic recording layer made of a granular material, and
a third magnetic recording layer made of a non-granular material.

2. The magnetic recording medium according to claim 1, wherein
the first magnetic recording layer has an anisotropic magnetic field higher than an anisotropic magnetic field of the second magnetic recording layer.

3. The magnetic recording medium according to claim 1, wherein
the first magnetic recording layer has an anisotropic magnetic field lower than an anisotropic magnetic field of the second magnetic recording layer.

4. The magnetic recording medium according to claim 1, wherein
the first magnetic recording layer and the second magnetic recording layer are made of a granular material containing a CoCrPt alloy and an oxide, and
the third magnetic recording layer is made of an alloy material containing CoCrPt.

5. The magnetic recording medium according to claim 1, wherein
the exchange-coupling-strength control layer is made of Ru.

6. A magnetic recording apparatus including a magnetic recording medium for vertical magnetic recording, the magnetic recording medium including
a substrate, and
a layer laminated on the substrate, including
a first magnetic recording layer made of a granular material,
an exchange-coupling-strength control layer,
a second magnetic recording layer made of a granular material, and
a third magnetic recording layer made of a non-granular material.

7. The magnetic recording apparatus according to claim 6, wherein
the first magnetic recording layer has an anisotropic magnetic field higher than an anisotropic magnetic field of the second magnetic recording layer.

8. The magnetic recording apparatus according to claim 6, wherein
the first magnetic recording layer has an anisotropic magnetic field lower than an anisotropic magnetic field of the second magnetic recording layer.

9. The magnetic recording apparatus according to claim 6, wherein
the first magnetic recording layer and the second magnetic recording layer are made of a granular material containing a CoCrPt alloy and an oxide, and
the third magnetic recording layer is made of an alloy material containing CoCrPt.

10. The magnetic recording apparatus according to claim 6, wherein
the exchange-coupling-strength control layer is made of Ru.
